(19) United States
(12) Patent Application Publication
(10) Pub. No.: US 2026/0257483 A1
(43) Pub. Date: Sep. 3, 2026

(54) LIQUID CONTAINER AND METHOD OF POURING LIQUID INTO LIQUID CONTAINER

(71) Applicant: SEIKO EPSON CORPORATION, Tokyo (JP)

(72) Inventors: Yoshihiro KOIZUMI, Shiojiri-shi (JP); Hiroto HANBA, Shiojiri-shi (JP)

(73) Assignee: SEIKO EPSON CORPORATION, Tokyo (JP)

(21) Appl. No.: 19/552,545

(22) Filed: Feb. 27, 2026

(30) Foreign Application Priority Data
Feb. 28, 2025 (JP) 2025-031282

(51) Int. Cl. B41J 2/175

(52) U.S. Cl. CPC B41J 2/17523; B41J 2/17509; B41J 2/17553; B41J 2/17596

(57) ABSTRACT

A liquid container includes a containing bag that contains a liquid and a supply unit attached to the containing bag. The supply unit includes a liquid supply port connectable to a supply pipe of a liquid ejecting apparatus, a liquid supply flow path connecting an inside of the containing bag and the liquid supply port, a liquid filling port, separately from the liquid supply port, capable of pouring a liquid into the containing bag, a liquid filling flow path connecting the liquid filling port and the inside of the containing bag, and a valve structure openable and closable a plurality of times in the liquid filling flow path.

### CROSS REFERENCE TO RELATED APPLICATIONS

The present application is based on, and claims priority from JP Application Serial Number 2025-031282, filed February 28, 2025, the disclosure of which is hereby incorporated by reference herein in its entirety.

### BACKGROUND

### 1. Technical Field

The present disclosure relates to a liquid container and a method of pouring a liquid into a liquid container.

### 2. Related Art

For example, JP-A-2014-233947 discloses a liquid container including a liquid containing bag for containing ink, which is an example of a liquid, and a liquid supply port for supplying the liquid contained in the liquid containing bag to a liquid ejecting apparatus. In such a liquid container, a liquid filling port for pouring ink into the liquid containing bag is provided separately from the liquid supply port. As a method of pouring a liquid into such a liquid container, after ink is poured into the liquid containing bag through the liquid filling port, the liquid filling port is closed by thermal caulking or the like.

However, in such a liquid container, the liquid filling port is closed after the liquid is poured. Accordingly, the liquid cannot be re-poured into the liquid container. Therefore, it is desired to improve the reusability of the liquid container.

### SUMMARY

According to an aspect of the present disclosure, there is provided a liquid container including a containing bag that contains a liquid, and a supply unit attached to the containing bag, in which the supply unit includes a liquid supply port connectable to a supply pipe of a liquid ejecting apparatus, a liquid supply flow path connecting an inside of the containing bag and the liquid supply port, a liquid filling port, separately from the liquid supply port, capable of pouring a liquid into the containing bag, a liquid filling flow path connecting the liquid filling port and the inside of the containing bag, and a valve structure openable and closable a plurality of times in the liquid filling flow path.

According to an aspect of the present disclosure, there is provided a method of pouring a liquid into a liquid container, the liquid container including a containing bag that contains a liquid and a supply unit attached to the containing bag, the supply unit including a liquid supply port connectable to a supply pipe of a liquid ejecting apparatus, a liquid supply flow path connecting an inside of the containing bag and the liquid supply port, a liquid filling port, separately from the liquid supply port, capable of pouring a liquid into the containing bag, a liquid filling flow path connecting the liquid filling port and the inside of the containing bag, and a valve structure openable and closable a plurality of times in the liquid filling flow path, the method including, in a state where the valve structure is open, pouring a liquid from a filling pipe different from the supply pipe into the containing bag, and closing the valve structure after the liquid from the filling pipe is poured into the containing bag.

### BRIEF DESCRIPTION OF THE DRAWINGS

FIG. 1 is a schematic diagram illustrating a liquid ejecting apparatus of a first embodiment.

FIG. 2 is a sectional view illustrating a liquid container of the first embodiment.

FIG. 3 is a sectional view illustrating a liquid container of a second embodiment.

FIG. 4 is a sectional view illustrating a liquid container of a third embodiment.

### DESCRIPTION OF EMBODIMENTS

### First Embodiment

Hereinafter, an embodiment of a liquid container and a method of pouring a liquid into the liquid container will be described with reference to the drawings. Configuration of Liquid Ejecting Apparatus 10

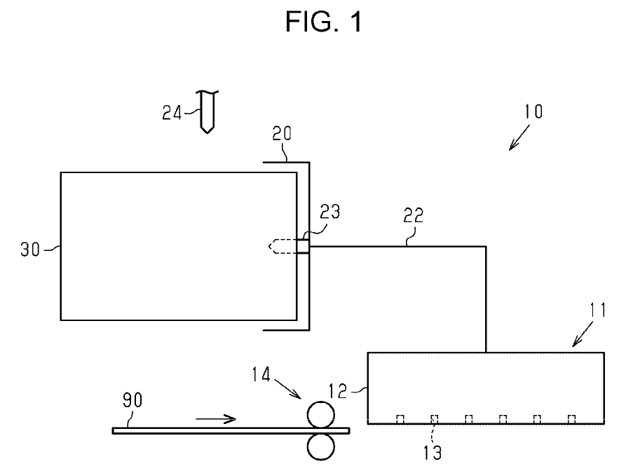

As illustrated in FIG. 1, a liquid ejecting apparatus 10 is configured to perform printing by ejecting a liquid onto a medium 90. The liquid ejecting apparatus 10 may be an ink jet printer that performs printing by ejecting ink, which is an example of the liquid, onto the medium 90. The medium 90 may be, for example, paper, fabric, vinyl, a plastic component, or a metal component.

The liquid ejecting apparatus 10 includes a liquid ejecting unit 11. The liquid ejecting unit 11 is configured to eject a liquid onto the medium 90. The liquid ejecting unit 11 includes a liquid ejecting head 12. The liquid ejecting head 12 ejects a liquid onto the medium 90. The liquid ejecting head 12 is configured to eject a liquid contained in a liquid container 30 described later.

The liquid ejecting head 12 includes a plurality of nozzles 13. The liquid ejecting head 12 performs printing by ejecting a liquid onto the medium 90 from each of the plurality of nozzles 13. The liquid ejecting head 12 may be of a serial type or a line type. The serial type liquid ejecting head 12 performs printing by ejecting a liquid onto the medium 90 while moving. The line type liquid ejecting head 12 is elongated in a width direction of the medium 90 and performs printing by ejecting a liquid onto the medium 90.

The liquid ejecting apparatus 10 may include a transport unit 14. The transport unit 14 is configured to transport the medium 90. The transport unit 14 transports the medium 90 from a medium accommodation unit (not illustrated) to the liquid ejecting head 12. The transport unit 14 transports the medium 90 on which printing is performed by the liquid ejecting head 12 to an outside of the liquid ejecting apparatus 10. The transport unit 14 may include a roller.

The liquid ejecting apparatus 10 may include a mounting portion 20. The liquid container 30 is detachable from the mounting portion 20. A plurality of the liquid containers 30 corresponding to colors of the liquid may be mountable on the mounting portion 20. The liquid container 30 contains a liquid to be supplied to the liquid ejecting head 12. The liquid container 30 may be an ink cartridge.

The liquid ejecting apparatus 10 may include a supply flow path 22. The liquid ejecting apparatus 10 may include a plurality of the supply flow paths 22 corresponding to the colors of the liquid. The supply flow path 22 is a flow path for supplying the liquid to the liquid ejecting head 12 from the liquid container 30 mounted on the mounting portion 20. When the liquid container 30 is mounted on the mounting portion 20, an upstream end of the supply flow path 22 is connected to the liquid container 30. A downstream end of the supply flow path 22 is connected to the liquid ejecting head 12.

The liquid ejecting apparatus 10 includes a supply pipe 23. The supply pipe 23 is provided at the upstream end of the supply flow path 22. The supply pipe 23 can be inserted into the liquid container 30 mounted on the mounting portion 20. The supply pipe 23 may be a supply needle. The liquid ejecting apparatus 10 may include a pump (not illustrated) that supplies the liquid from the liquid container 30 to the liquid ejecting head 12. The supply flow path 22 may supply the liquid by a water head.

A filling pipe 24 can be inserted into the liquid container 30 when the liquid container 30 is detached from the mounting portion 20. The filling pipe 24 is different from the supply pipe 23. The filling pipe 24 is a member for pouring a liquid into the liquid container 30. When the filling pipe 24 is inserted into the liquid container 30, the liquid can be poured from a liquid filling container (not illustrated) into the liquid container 30. The filling pipe 24 may have the same shape as the supply pipe 23.

### Configuration of Liquid Container 30

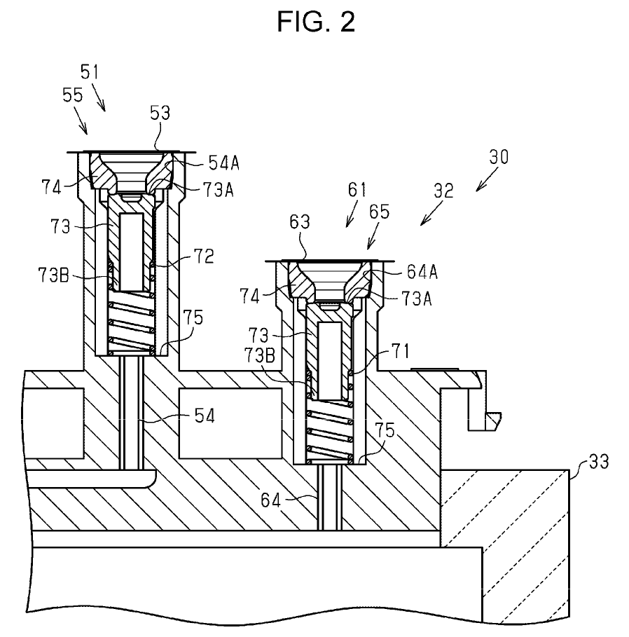

As illustrated in FIG. 2, the liquid container 30 includes a supply unit 32 and a containing bag 33. The containing bag 33 contains a liquid. The containing bag 33 is made of, for example, a flexible material. The containing bag 33 has a bag shape.

The supply unit 32 is a member for supplying the liquid contained in the containing bag 33 to the outside. The supply unit 32 is attached to the containing bag 33. Specifically, the supply unit 32 closes an open region of the containing bag 33. The supply unit 32 is attached to the containing bag 33 by, for example, thermal welding. As a result, the containing bag 33 is sealed.

The supply unit 32 includes a liquid supply unit 51. The liquid supply unit 51 is configured to supply the liquid from the containing bag 33 to the outside. When the liquid container 30 is mounted on the mounting portion 20, the liquid supply unit 51 supplies the liquid from the containing bag 33 to the liquid ejecting apparatus 10.

The liquid supply unit 51 includes a liquid supply port 53 and a liquid supply flow path 54. That is, the supply unit 32 includes the liquid supply port 53 and the liquid supply flow path 54. The liquid supply port 53 is in communication with an inside of the containing bag 33 via the liquid supply flow path 54.

The liquid supply port 53 is connectable to the supply pipe 23 of the liquid ejecting apparatus 10. In particular, when the liquid container 30 is mounted on the mounting portion 20, the supply pipe 23 is inserted into the liquid supply port 53. The liquid supply port 53 may be closed by a film before the liquid container 30 is mounted on the mounting portion 20.

The liquid supply flow path 54 connects the inside of the containing bag 33 and the liquid supply port 53. The liquid supply flow path 54 may include a check valve in a direction in which the liquid does not leak from the inside of the containing bag 33 through the liquid supply port 53.

The liquid supply unit 51 may include a second valve structure 55. That is, the supply unit 32 may include the second valve structure 55. The second valve structure 55 is provided in the liquid supply flow path 54. The second valve structure 55 is a valve structure openable and closable a plurality of times in the liquid supply flow path 54. The second valve structure 55 is opened by inserting the supply pipe 23. The second valve structure 55 is closed by removing the supply pipe 23. A packing 74 described later may be press-fitted into an inner wall surface 54A constituting the liquid supply flow path 54.

The second valve structure 55 may include a second spring member 72. The second valve structure 55 may be a valve structure including the second spring member 72. The second valve structure 55 is closed by an elastic force of the second spring member 72. The second valve structure 55 is opened against the elastic force of the second spring member 72.

The supply unit 32 includes a liquid filling unit 61. The liquid filling unit 61 is configured to pour a liquid into the containing bag 33. The liquid filling unit 61 can pour a liquid into the containing bag 33.

The liquid filling unit 61 includes a liquid filling port 63 and a liquid filling flow path 64. That is, the supply unit 32 includes the liquid filling port 63 and the liquid filling flow path 64. The liquid filling port 63 is provided separately from the liquid supply port 53. The liquid filling port 63 is in communication with the inside of the containing bag 33 via the liquid filling flow path 64. When the liquid is poured into the containing bag 33, the filling pipe 24 is inserted into the liquid filling port 63. The liquid filling port 63 is configured to pour a liquid into the containing bag 33 through the liquid filling flow path 64. The liquid filling port 63 may be closed by a film before the liquid container 30 is mounted on the mounting portion 20.

The liquid filling flow path 64 connects the liquid filling port 63 and the inside of the containing bag 33. The liquid filling flow path 64 may include a check valve in a direction in which the liquid does not leak from the inside of the containing bag 33 through the liquid filling port 63.

The liquid filling unit 61 may include a first valve structure 65. That is, the supply unit 32 may include the first valve structure 65. The first valve structure 65 is provided in the liquid filling flow path 64. The first valve structure 65 is a valve structure openable and closable a plurality of times in the liquid filling flow path 64. The first valve structure 65 is opened by inserting the filling pipe 24. The first valve structure 65 is closed by removing the filling pipe 24.

The first valve structure 65 may include a first spring member 71. The first valve structure 65 may be a valve structure including the first spring member 71. The first valve structure 65 is closed by an elastic force of the first spring member 71. The first valve structure 65 is opened against the elastic force of the first spring member 71.

Specifically, the first valve structure 65 includes the first spring member 71, a plug 73, and the packing 74. The packing 74 is formed of, for example, an elastic body such as rubber or an elastomer. The packing 74 is provided at an end of the liquid filling flow path 64. The packing 74 is press-fitted into an inner wall surface 64A constituting the liquid filling flow path 64.

The plug 73 opens and closes the first valve structure 65. The plug 73 is provided in the liquid filling flow path 64. The plug 73 is provided further on an inner side than is the packing 74 in the liquid filling flow path 64. A first end portion 73A of the plug 73 can come into contact with the packing 74. A second end portion 73B of the plug 73 is inserted into the first spring member 71. The plug 73 is slidable along the liquid filling flow path 64.

The first spring member 71 is provided in the liquid filling flow path 64. The first spring member 71 is provided further on an inner side than is the plug 73 in the liquid filling flow path 64. The second end portion 73B of the plug 73 is inserted into the first spring member 71. The first spring member 71 applies an elastic force to the plug 73 toward the packing 74.

The liquid filling unit 61 includes a holding surface 75. The holding surface 75 is provided in the liquid filling flow path 64. The holding surface 75 is an inner wall surface of the liquid filling flow path 64. The holding surface 75 is a surface that holds the first spring member 71.

When the filling pipe 24 is not inserted into the liquid filling port 63, the first end portion 73A of the plug 73 comes into contact with the packing 74 by the elastic force from the first spring member 71. As a result, the first valve structure 65 is closed.

When the filling pipe 24 is inserted into the liquid filling port 63, the filling pipe 24 slides the plug 73 against the elastic force from the first spring member 71 so that the first end portion 73A of the plug 73 is separated from the packing 74. As a result, the first valve structure 65 is opened.

In particular, the liquid can be poured into the containing bag 33 through the liquid filling port 63 a plurality of times including pouring of the liquid into the liquid container 30 for the first time and re-pouring of the liquid into the liquid container 30 for the second and subsequent times.

As described above, in a method of pouring a liquid into the liquid container 30, the first valve structure 65 is opened by inserting the filling pipe 24 into the liquid filling port 63. In a state where the first valve structure 65 is opened, the liquid from the filling pipe 24 can be poured into the containing bag 33. After the liquid from the filling pipe 24 is poured into the containing bag 33, the filling pipe 24 is removed from the liquid filling port 63. As a result, the first valve structure 65 is closed.

### Operation and Effect of First Embodiment

The operation and effect of the first embodiment will be described.

1-1 The supply unit 32 includes the liquid filling port 63, the liquid filling flow path 64, and the first valve structure 65. The first valve structure 65 is openable and closable a plurality of times in the liquid filling flow path 64. According to this configuration, the liquid container 30 can pour the liquid into the containing bag 33 from the liquid filling port 63 a plurality of times. As a result, the liquid can be poured into the liquid container 30 a plurality of times. Therefore, the reusability of the liquid container 30 can be improved.

In particular, the liquid can be re-poured into the liquid container 30 a plurality of times without opening a hole in the containing bag 33 and closing the hole opened in the containing bag 33 each time the liquid is poured. The liquid can be re-poured into the liquid container 30 a plurality of times without closing the liquid filling port 63 after the liquid is poured into the containing bag 33 through the liquid filling port 63 or opening a hole in the closed liquid filling port 63. Even if the liquid is not poured through the liquid supply port 53, the liquid can be poured into the liquid container 30 a plurality of times.

1-2 The first valve structure 65 is opened by inserting the filling pipe 24. The first valve structure 65 is closed by removing the filling pipe 24. According to this configuration, the first valve structure 65 can be opened and closed by inserting and removing the filling pipe 24.

1-3 The first valve structure 65 is closed by the elastic force of the first spring member 71. The first valve structure 65 is opened against the elastic force of the first spring member 71. The second valve structure 55 is closed by the elastic force of the second spring member 72. The second valve structure 55 is opened against the elastic force of the second spring member 72. According to this configuration, the first valve structure 65 and the second valve structure 55 can be opened and closed in the same manner by using the first spring member 71 and the second spring member 72, respectively.

### Second Embodiment

Next, a second embodiment will be described. In the following description, redundant description of the same configurations as those in the embodiment already described will be omitted or simplified, and configurations different from those in the embodiment already described will be described.

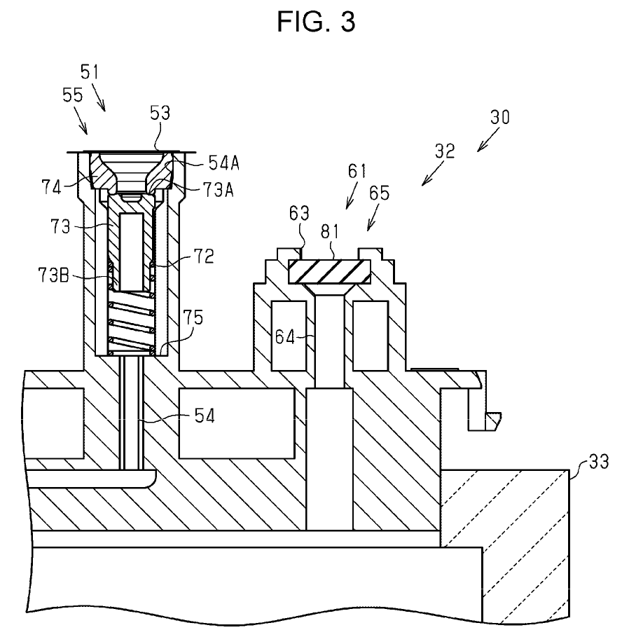

As illustrated in FIG. 3, in the second embodiment, the first valve structure 65 may include an elastic member 81. The elastic member 81 may be, for example, rubber. The elastic member 81 can be press-fitted into the liquid filling port 63. The elastic member 81 can be press-fitted into the liquid filling flow path 64.

The elastic member 81 is fixed to an inside of the liquid filling port 63 so as to close the liquid filling flow path 64. The elastic member 81 may be provided at any position of the liquid filling flow path 64 as long as the elastic member 81 can block the inside and the outside of the containing bag 33. The elastic member 81 is fixed to the inside of the liquid filling port 63 by thermal caulking or the like. The filling pipe 24 may be a sharp-ended pipe.

The first valve structure 65 is opened when filling pipe 24 passes through the elastic member 81. As a result, the liquid can be poured into the containing bag 33 through the liquid filling port 63. When the filling pipe 24 is removed from the elastic member 81, the first valve structure 65 is closed by closing a through-hole formed by the filling pipe 24. As a result, the inside and the outside of the containing bag 33 are blocked.

### Operation and Effect of Second Embodiment

The operation and effect of the second embodiment will be described.

2-1 The first valve structure 65 includes the elastic member 81 that can be press-fitted into the liquid filling port 63. The first valve structure 65 is opened when the filling pipe 24 passes through the elastic member 81. According to this configuration, the first valve structure 65 can open and close the liquid filling port 63 without using the first spring member 71, the plug 73, and the packing 74. As a result, the first valve structure 65 can be configured with a smaller number of members.

### Third Embodiment

Next, a third embodiment will be described.

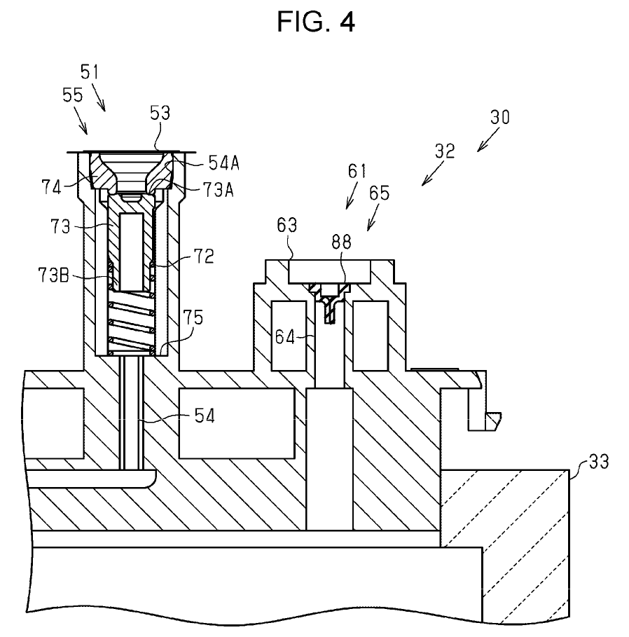

As illustrated in FIG. 4, in the third embodiment, the first valve structure 65 may be a duckbill valve 88. The duckbill valve 88 can be press-fitted into the liquid filling port 63. The duckbill valve 88 can be press-fitted into the liquid filling flow path 64. The duckbill valve 88 is a check valve through which the liquid passes in a direction of the liquid being poured from the liquid filling port 63 into the containing bag 33. The liquid filling unit 61 may include a check valve other than the duckbill valve 88 instead of the duckbill valve 88.

When the duckbill valve 88 is used in the first valve structure 65, the duckbill valve 88 is opened by an inflow pressure of the liquid. That is, the first valve structure 65 may be opened by starting liquid feeding and may be closed by stopping the liquid feeding.

### Operation and Effect of Third Embodiment

The operation and effect of the third embodiment will be described.

3-1 The first valve structure 65 is the duckbill valve £36. According to this configuration, the first valve structure 65 can open and close the liquid filling port 63 without using the first spring member 71, the plug 73, and the packing 74. As a result, the valve structure can be configured with a smaller number of members. In addition, the liquid can be poured without using the filling pipe 24.

### Modifications

The embodiments presented herein can be modified and implemented as follows. The embodiments and the following modifications can be implemented in combination with each other in a technically consistent range.

In the first embodiment, the first valve structure 65 and the second valve structure 55 may have the same structure, or may have different structures such as different sizes. In the first embodiment, the liquid supply unit 51 and the liquid filling unit 61 may have the same configuration. The first spring member 71 and the second spring member 72 may be members of the same type.

In the second embodiment, the elastic member 81 need only be able to close the through-hole formed by the filling pipe 24 by a press-fitting force. The elastic member 81 may be, for example, an elastic body such as an elastomer.

In the third embodiment, the liquid may be poured into the containing bag 33 by inserting the filling pipe 24 into the liquid filling port 63. In the third embodiment, removal of bubbles from the inside of the containing bag 33 may be promoted by inserting a flow path pipe (not illustrated) into the liquid filling port 63. In the third embodiment, in the supply unit 32, a mechanism for removing bubbles in the containing bag 33 may be provided separately from the liquid filling unit 61. As a result, inserting of the filling pipe 24 from the liquid filling port 63 is not necessary for removing bubbles from the containing bag 33.

The second valve structure 55 may have any configuration. The second valve structure 55 may have a configuration using the second spring member 72, or does not have to have the same configuration as the first valve structure 65 using the first spring member 71. The second spring member 72 may be the same as the first spring member 71 or may be different from the first spring member 71.

The liquid container 30 may be accommodated in a case. The liquid supply port 53 may be exposed from the case. The liquid filling port 63 may be exposed from the case. A gripping handle may be attachable to the liquid container 30. An adapter for assisting mounting of the liquid container 30 on the mounting portion 20 can be mounted on the liquid container 30.

Any liquid can be selected as long as the liquid can be attached to the medium 90 and recorded on the medium 90. For example, ink includes those in which particles of functional materials made of solid substances such as pigments and metal particles are dissolved, dispersed, or mixed in a solvent, and includes various compositions such as water-based ink, oil-based ink, gel ink, and hot melt ink.

The expression "at least any one" used in the present specification means one or more of desired options. As an example, the expression "at least any one" used in the present specification means only one option or both of two options when the number of options is two. In another example, the expression "at least any one" used in the present specification means only one option or a combination of any two or more options when the number of options is three or more.

### Additional Notes

Hereinafter, the technical ideas and the operation and effect understood from the above-described embodiments and modifications will be described. The technical ideas and the operation and effect thereof can be combined with each other in a technically consistent range.

1. A liquid container including a containing bag that contains a liquid, and a supply unit attached to the containing bag, in which the supply unit includes a liquid supply port connectable to a supply pipe of a liquid ejecting apparatus, a liquid supply flow path connecting an inside of the containing bag and the liquid supply port, a liquid filling port, separately from the liquid supply port, capable of pouring a liquid into the containing bag, a liquid filling flow path connecting the liquid filling port and the inside of the containing bag, and a valve structure openable and closable a plurality of times in the liquid filling flow path.

According to this configuration, the liquid container can pour the liquid into the containing bag from the liquid filling port a plurality of times. As a result, the liquid can be poured into the liquid container a plurality of times. Therefore, the reusability of the liquid container can be improved.

2. In the liquid container described above, the valve structure is opened by inserting a filling pipe different from the supply pipe and is closed by removing the filling pipe. According to this configuration, the valve structure can be opened and closed by inserting and removing the filling pipe.

3. In the liquid container described above, the supply unit includes a second valve structure openable and closable a plurality of times in the liquid supply flow path, the valve structure is a first valve structure, the first valve structure is closed by an elastic force of a first spring member and is opened against the elastic force of the first spring member, and the second valve structure is closed by an elastic force of a second spring member and is opened against the elastic force of the second spring member.

According to this configuration, the first valve structure and the second valve structure can be opened and closed in the same manner by using the first spring member and the second spring member, respectively.

4. In the liquid container described above, the valve structure includes an elastic member capable of being press-fitted into the liquid filling port and is opened when the filling pipe passes through the elastic member.

According to this configuration, the valve structure can be configured with a smaller number of members than the valve structure using a spring member.

5. In the liquid container described above, the valve structure is a duckbill valve. According to this configuration, the valve structure can be configured with a smaller number of members than the valve structure using a spring member.

6. A method of pouring a liquid into a liquid container, the liquid container including a containing bag that contains a liquid and a supply unit attached to the containing bag, the supply unit including a liquid supply port connectable to a supply pipe of a liquid ejecting apparatus, a liquid supply flow path connecting an inside of the containing bag and the liquid supply port, a liquid filling port, separately from the liquid supply port, capable of pouring a liquid into the containing bag, a liquid filling flow path connecting the liquid filling port and the inside of the containing bag, and a valve structure openable and closable a plurality of times in the liquid filling flow path, the method including, in a state where the valve structure is open, pouring a liquid from a filling pipe different from the supply pipe into the containing bag, and closing the valve structure after the liquid from the filling pipe is poured into the containing bag. According to this configuration, the same effect as 1. can be achieved.

What is claimed is:

1. A liquid container comprising:
a containing bag that contains a liquid; and
a supply unit attached to the containing bag, wherein
the supply unit includes
a liquid supply port connectable to a supply pipe of a liquid ejecting apparatus,
a liquid supply flow path connecting an inside of the containing bag and the liquid supply port,
a liquid filling port, separately from the liquid supply port, capable of pouring a liquid into the containing bag,
a liquid filling flow path connecting the liquid filling port and the inside of the containing bag, and
a valve structure openable and closable a plurality of times in the liquid filling flow path.

2. The liquid container according to claim 1, wherein
the valve structure is opened by inserting a filling pipe different from the supply pipe and is closed by removing the filling pipe.

3. The liquid container according to claim 2, wherein
the supply unit includes a second valve structure openable and closable a plurality of times in the liquid supply flow path,
the valve structure is a first valve structure,
the first valve structure is closed by an elastic force of a first spring member and is opened against the elastic force of the first spring member, and
the second valve structure is closed by an elastic force of a second spring member and is opened against the elastic force of the second spring member.

4. The liquid container according to claim 2, wherein
the valve structure includes an elastic member capable of being press-fitted into the liquid filling port and is opened when the filling pipe passes through the elastic member.

5. The liquid container according to claim 1, wherein
the valve structure is a duckbill valve.

6. A method of pouring a liquid into a liquid container, the liquid container including a containing bag that contains a liquid and a supply unit attached to the containing bag,
the supply unit including
a liquid supply port connectable to a supply pipe of a liquid ejecting apparatus,
a liquid supply flow path connecting an inside of the containing bag and the liquid supply port,
a liquid filling port, separately from the liquid supply port, capable of pouring a liquid into the containing bag,
a liquid filling flow path connecting the liquid filling port and the inside of the containing bag, and
a valve structure openable and closable a plurality of times in the liquid filling flow path, the method comprising:
in a state where the valve structure is open, pouring a liquid from a filling pipe different from the supply pipe into the containing bag; and
closing the valve structure after the liquid from the filling pipe is poured into the containing bag.
